(19) United States
(12) Patent Application Publication
(10) Pub. No.: US 2023/0245798 A1
(43) Pub. Date: Aug. 3, 2023

(54) SOLAR CABLE RETENTION CLIPS AND SYSTEMS

(71) Applicant: SHOALS TECHNOLOGIES GROUP, LLC, Portland, TN (US)

(72) Inventors: Dorothy MICHAEL, Greenbrier, TN (US); Dean SOLON, Gallatin, TN (US)

(21) Appl. No.: 18/295,827

(22) Filed: Apr. 4, 2023

Related U.S. Application Data
(63) Continuation of application No. 17/735,778, filed on May 3, 2022.
(60) Provisional application No. 63/201,587, filed on May 5, 2021.
(60) Provisional application No. 63/262,848, filed on Oct. 21, 2021.
(60) Provisional application No. 63/329,683, filed on Apr. 11, 2022.

(51) Int. Cl. H01B 7/00; H02S 40/30; H02G 3/32; H02G 3/04

(52) U.S. Cl. CPC H01B 7/0045; H02S 40/30; H02G 3/32; H02G 3/0456; H02S 20/10

(57) ABSTRACT

A cable retention clip includes first and second bodies. The first body defines a pair of first cable retention channels that are positioned adjacent with each other. Each first cable retention channel has a parallel channel axis and a first inlet opening extending a length of each first cable retention channel. The first body portion has a first base side opposite of each first inlet opening. The second body defines multiple second cable retention channels that are positioned adjacent with each other. Each second cable retention channel has a parallel channel axis and a second inlet opening extending a length of each second cable retention channel. The second body portion has a second base side opposite of each second inlet opening. The first base side is coupled to the second base side such that each first inlet opening opens in a direction opposite of each second inlet opening.

### CROSS-REFERENCE TO RELATED APPLICATIONS

This patent application is a continuation of U.S. patent application Ser. No. 17/735,778 filed May 3, 2022 which claims the benefit of and priority to U.S. Provisional Application No. 63/201,587 filed May 5, 2021, to U.S. Provisional Application No. 63/262,848 filed Oct. 21, 2021, and to U.S. Provisional Application No. 63/329,683 filed Apr. 11, 2022. Each of the Ser. No. 17/735,778 application, the 63/201,587 application, the 63/262,848 application, and the 63/329,683 application is incorporated herein by specific reference in its entirety.

### BACKGROUND

### Field

The present disclosure relates to solar panel cable retention clips for securing and organizing solar panel cables in solar panel installations.

### Description of Related Art

Solar power has long been considered a niche utility. It is considered desirable from an environmental and political standpoint, but perhaps not economically feasible for generating enough power to make a meaningful contribution to the grid. However, as the problems associated with our dependence on fossil fuels have become better understood, more attention has been paid to so-called alternative energy such as solar power. This attention has led to significant technological and policy advances, such that solar power is now quite prevalent, and more economically feasible.

Technological advances in the generation of solar energy have occurred in multiple areas, including collector material and structure, and wiring infrastructure. Wiring infrastructure, however, continues to present challenges, particularly in large scale solar photovoltaic (PV) panel array installations. Proper wire management is vital to the health of the PV system. Damaged wire insulation can lead to ground-faults, system downtime and fire. Moreover, PV systems are installed in various geographic locations, and experience extreme weather and environmental conditions. The wiring infrastructure must defy wind and weather conditions for many years and must reliably safeguard various electricity yields. The sheer number of cables associated with a typical PV array installation adds to the difficulty in providing efficient and effective wire management.

In addition, PV modules are often mounted to solar tracking systems and the like via bracket or clamp systems. The PV modules are moved to maximize sun exposure. Thus, it is desirable to orient the cables in a manner that accommodates movement of respective PV modules, and in a manner that avoids entanglement or damage to the cables themselves.

To date, there are inadequate tools available to organize and manage the large number of cables often found within a typical PV array installation. Often, installers are left to using zip ties or the like, which, at best, groups cables in a haphazard manner. Such approaches make it difficult to organize cables with respect to the panels and the panel support structures. Moreover, for purposes of repair and maintenance, this approach requires ties to be cut, and then re-established with new ties, which is time consuming, and can lead to damage to the cables/wires when a zip tie is cut.

The claimed subject matter is not limited to embodiments that solve any disadvantages or that operate only in environments such as those described above. This background is only provided to illustrate examples of where the present disclosure may be utilized.

### SUMMARY

In some embodiments, a cable retention clip is provided. The cable retention clip may include a first body portion and a second body portion. The first body portion may be shaped to define at least a pair of first cable retention channels that are positioned adjacent with each other. Each first cable retention channel has a channel axis, the channel axes being parallel to each other. Each first cable retention channel includes a first inlet opening extending a length of each first cable retention channel. The first body portion has a first base side that is opposite of each first inlet opening. The second body portion defines multiple second cable retention channels that are positioned adjacent with each other. Each second cable retention channel has a parallel channel axis with respect to the other second cable retention channels. A second inlet opening is formed in each second cable retention channel that extends a length of each second cable retention channel. The second body portion has a second base side opposite of each second inlet opening. The first base side of the first body portion is coupled to the second base side of the second body portion such that each first inlet opening opens in a direction opposite of each second inlet opening. The coupling may be by any joining, such as by being adhered together, welded or brazed, or integrated by being formed of the same material. Injection molding may be used to form the first body and second body joined together.

In some embodiments, a cable arrangement may include a cable retention clip with a pair of lead wires and multiple secondary wires coupled with the cable retention clip. The pair of lead wires may be configured as solar lead wires. Each lead wire is located in a first cable retention channel. The secondary wires may be configured as solar secondary wires, which are smaller than the lead wires. Each secondary wire located in a second cable retention channel.

In some embodiments, a solar installation may include a cable retention clip, a pair of lead wires, multiple secondary wires, and at least one solar panel. The pair of lead wires may be configured as solar lead wires. Each lead wire is located in a first cable retention channel. The secondary wires may be configured as solar secondary wires. Each secondary wire is located in a second cable retention channel. There is at least one solar panel or array thereof operably coupled with at least one of the lead wires or secondary wires.

A method of hanging wires may be provided. Such a method may include using the retention clips described herein to couple lead wires to secondary wires for wire hanging in above ground solar installations. The method may include taking a lead wire cable and pressing it into a lead cable retention channel, such that the first body flexes to receive the lead wire cable, and then retracts to form the channel around the lead wire cable. That is, a curved arm, such as a C shape, may be flexed laterally to open the channel to receive the cable, and then the curved arm retracts to or at least towards its normal shape to retain the wire in the channel. The configuration for the channels and arms applies to the first channels and second channels of the cable retention clip.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and following information as well as other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 illustrates an example solar power cable installation that includes a messenger cable coupled to a structural pile and suspending lead cables.

FIG. 2A is a perspective view of an embodiment of a solar cable retention clip.

FIG. 2B is a front view of the solar cable retention clip of FIG. 2A.

FIG. 2C is a side view of the solar cable retention clip of FIG. 2A.

FIG. 2D is a top view of the solar cable retention clip of FIG. 2A.

FIG. 2E is a bottom view of the solar cable retention clip of FIG. 2A.

FIG. 3 is a front view of another embodiment of a solar cable retention clip.

FIG. 4 is a front view of another embodiment of a solar cable retention clip.

FIG. 5A is a perspective view of a solar cable retention clip retaining a pair of lead cables and a set of secondary cables.

FIG. 5B is a front view of the solar cable retention clip with a cross-sectional view of the pair of lead cables and set of secondary cables of FIG. 5A.

FIG. 6 is a perspective view of a solar installation having solar panels mounted on piles, with a cable arrangement having a solar cable retention clip retaining a pair of lead cables and a set of secondary cables.

FIG. 7A is a perspective view of another embodiment of a solar cable retention clip.

FIG. 7B is a bottom perspective view of the solar cable retention clip of FIG. 7A.

FIG. 7C is a front or back view of the solar cable retention clip of FIG. 7A.

FIG. 7D is a side view of the solar cable retention clip of FIG. 7A.

FIG. 7E is a top view of the solar cable retention clip of FIG. 7A.

FIG. 8A is a perspective view of another embodiment of a solar cable retention clip.

FIG. 8B is a bottom perspective view of the solar cable retention clip of FIG. 8A.

FIG. 8C is a front or back view of the solar cable retention clip of FIG. 8A.

FIG. 8D is a side view of the solar cable retention clip of FIG. 8A.

FIG. 8E is a top view of the solar cable retention clip of FIG. 8A.

FIG. 8F illustrates an embodiment of a solar power cable installation where the solar cable retention clip of FIG. 8A retains solar cables.

FIG. 9A is a perspective view of another embodiment of a solar cable retention clip.

FIG. 9B is a bottom perspective view of the solar cable retention clip of FIG. 9A.

FIG. 9C is a front view of the solar cable retention clip of FIG. 9A.

FIG. 9D is a first side view of the solar cable retention clip of FIG. 9A.

FIG. 9E is a second side view of the solar cable retention clip of FIG. 9A.

FIG. 9F is a top view of the solar cable retention clip of FIG. 9A.

FIG. 9G is a perspective view of a solar cable system having the solar cable retention clip of FIG. 9A coupled to different sized solar panel cables.

FIG. 10A illustrates an embodiment of a solar power cable installation where solar cable retention clips of FIG. 7A retain two solar panel cables together.

FIG. 10B illustrates an embodiment of a solar cable retention clip configured to retain a solar panel cable to a solar installation structural support member.

FIG. 10C illustrates an embodiment of a solar cable support arm configured to support a solar panel cable and retain the solar panel cable to a solar installation structural support member.

FIG. 10D illustrates another embodiment of a solar power cable installation where solar cable retention clips of FIG. 7A retain two solar panel cables together and the solar cable retention clip of FIG. 10B retains the two solar panel cables to a solar installation structural support member.

FIG. 10E illustrates another embodiment of a solar power cable installation where solar cable retention clips of FIG. 9A retain multiple solar panel cables together and the solar cable retention clip of FIG. 10B retains the two solar panel cables to a solar installation structural support member.

FIG. 11 illustrates a messenger cable support clip show in FIG. 1A.

### DETAILED DESCRIPTION

Reference will be made to the drawings and specific language will be used to describe various aspects of the disclosure. Using the drawings and description in this manner should not be construed as limiting its scope. Additional aspects may be apparent in light of the disclosure, including the claims, or may be learned by practice.

The present disclosure generally relates to cable retention clips and systems suitable for retention and management of solar wire cables (e.g., solar cables) within a photovoltaic (PV) solar panel array installation. Individually, disclosed retention clip embodiments may be used to retain multiple solar cables together in an organized manner, and in a manner that allows for easy installation and/or later repair to the solar cables and/or corresponding solar panels. The solar cable retention clips may be provided for retaining the solar cables together for organization and for holding the cables off of the ground. The solar cable retention clips may have different configurations for retaining different types of solar cables together or for retaining the same type of solar cables together. As such, the solar cable retention clips may have at least two different cable channels with different sizes (e.g., different diameter or lumen cross-sectional area) or at least two different cable channels all having the same size. This allows for unique solar cable retention clip systems for retaining and organizing the solar cables.

In some embodiments, the cable retention clips described herein may include one or more channels adapted for coupling to a big lead assembly (BLA) lead cable and/or coupling to multiple secondary cables. In some aspects, there are one or two BLA lead cable channels and three secondary cable channels for each BLA lead cable channel, resulting in two BLA lead cable channels and six secondary cable channels in some examples. However, other embodiments may include different numbers of secondary cable channels, such as four secondary cable channels, or two secondary cable channels, or any other integer. This allows for the solar cable retention clip to couple the secondary cables to the BLA lead cables. Moreover, disclosed embodiments of example solar cable retention clip embodiments may be used to retain secondary cables directly to the lead cables. As described herein, the solar cables may include electrically conducting wires within an insulation coating, and may be referred to as wire cables.

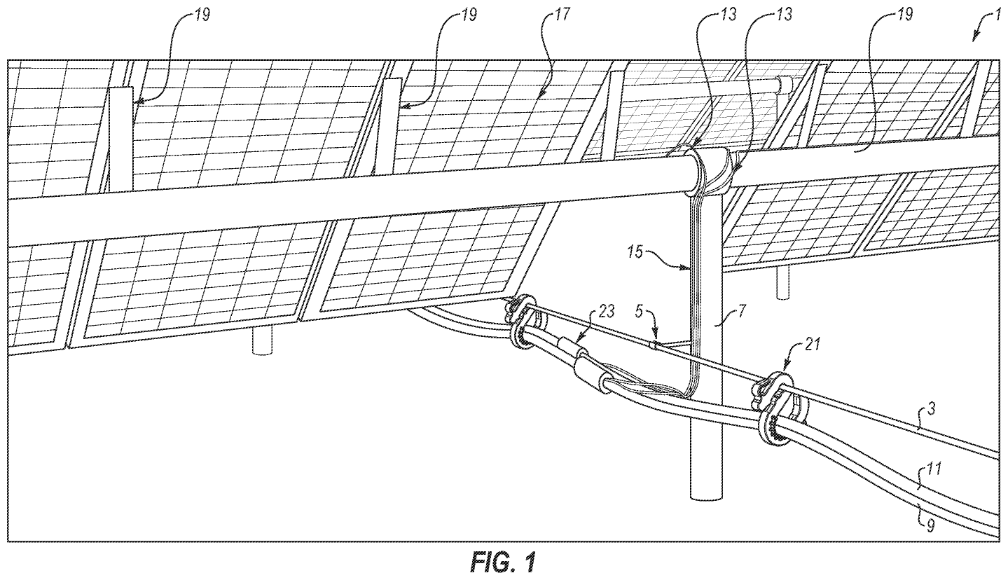

FIG. 1 shows an example solar infrastructure 1, arranged in accordance with at least one embodiment herein. FIG. 1 illustrates an example solar infrastructure 1 having multiple solar panels 17 supported by piles 7. The solar panels 17 are mounted to frames 19 that are mounted to the piles 7 for an above ground installation. The example solar infrastructure 1 includes a messenger cable 3 mounted via a hanger arm 5 to the pile 7 installed in the ground. A first big lead assembly (BLA) cable 9 (e.g., positive) and a second BLA cable 11 (e.g., negative) hang from the messenger cable 3. A cable hanger 21 hangs from the messenger cable 3 to carry the first and second BLA cables 9, 11. The first and second BLA cables 9, 11 may be trunk cables or lead cables that carry electricity from a group of solar panels 17 to a central component. A first secondary cable 13 (e.g., positive) and a second secondary cable 15 (e.g., negative), which are branch wire cables, run from the solar panel 17 to the pile 7. FIG. 1 illustrates the pile 7 as round but the pile 7 may more generally have any suitable shape or configuration, such as an H-pile. Junction connectors 23 connect the first secondary cables 13 to the first BLA cable 9 and the second secondary cables 15 to the second BLA cable 11. As shown, the messenger cable 3 structurally supports the first and second BLA cables 9, 11, e.g., to reduce mechanical stress or strain on the first and second BLA cables 9, 11. According to some embodiments herein, one or more lead cable and multi-cable clips may be used in the solar infrastructure 1, such as to couple the secondary cables 13, 15 to the lead cables 9, 11 hanging from the messenger cable 3. Some of the lead cable and multi-cable clips described herein may be used with or without a messenger cable (e.g., the messenger cable 3).

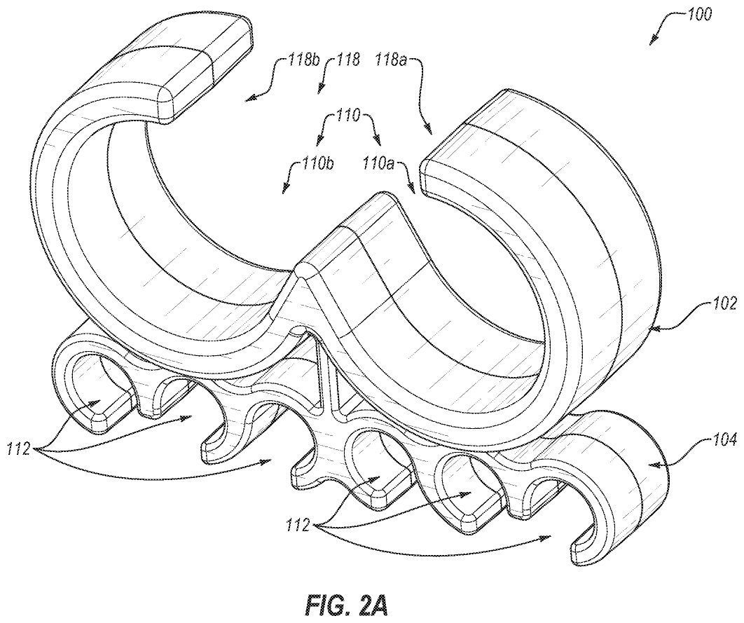

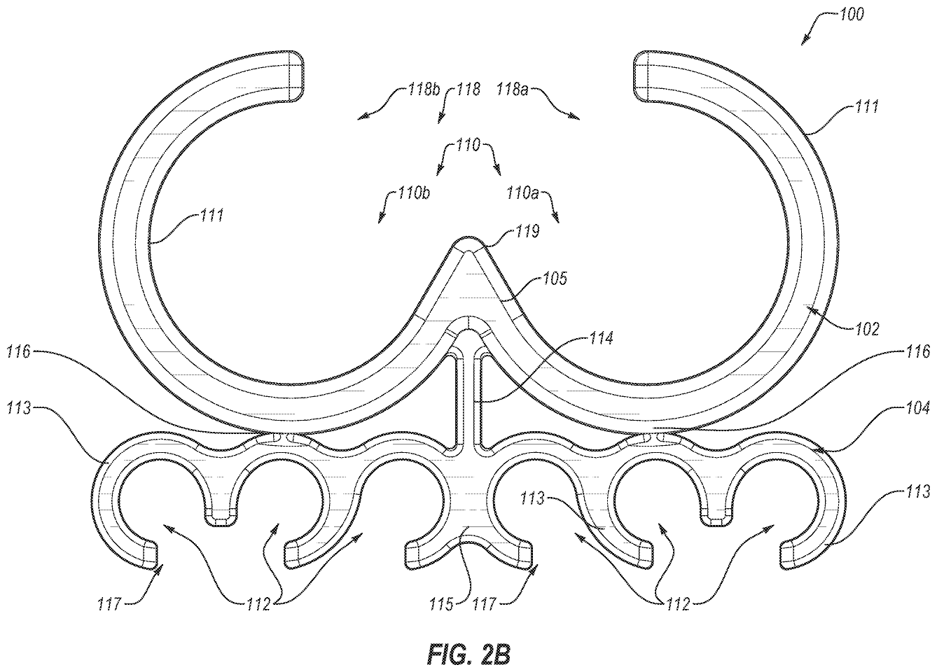

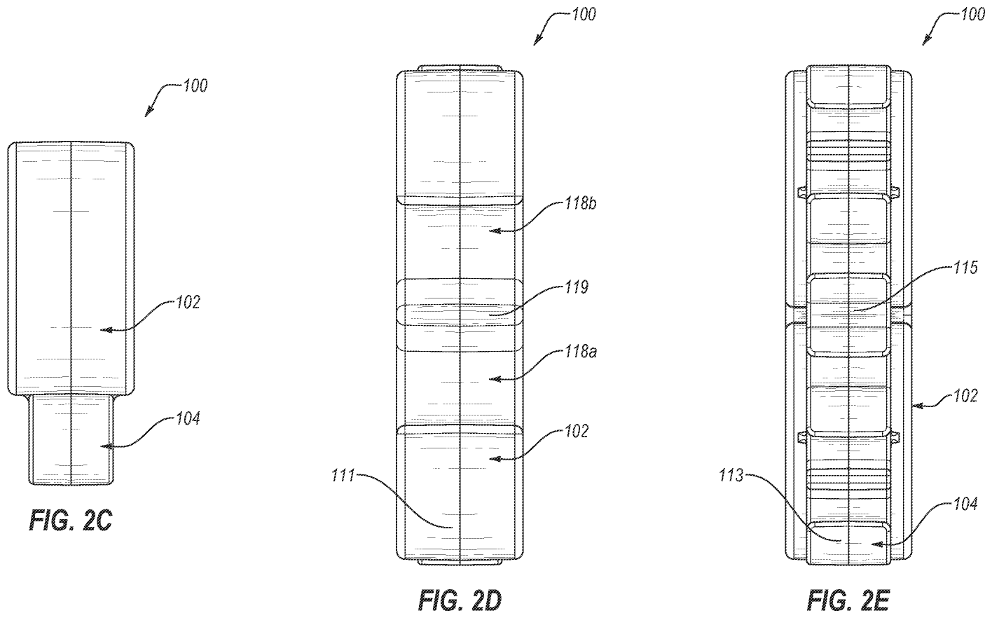

Reference is now made to FIGS. 2A-2E, which illustrate an embodiment of a cable retention clip 100, arranged in accordance with at least one embodiment herein. The cable retention clip 100 is an example of a lead cable and multi-cable clip. FIG. 2A is a perspective view of the cable retention clip 100. FIG. 2B is a front view of the cable retention clip 100; a back view of the cable retention clip 100 is identical to the front view of FIG. 2B. FIG. 2C is a left side view of the cable retention clip 100; a right side view of the cable retention clip is identical to the left side view of FIG. 2C. FIG. 2D is a top view of the cable retention clip 100. FIG. 2E is a bottom view of the cable retention clip 100.

As illustrated, the cable retention clip 100 has a lead cable clip section 102 (e.g., first body) and a secondary cable clip section 104 (e.g., second body). The lead cable clip section 102 is configured to be detachably attached to at least two different BLA lead cables in a solar installation system by including at least two lead cable channels 110, which are configured as retention channels (e.g., first cable retention channels). The secondary cable clip section 104 is configured to be detachably attached to multiple secondary cables in a solar installation system by including multiple secondary cable retention channels 112, where six secondary cable retention channels 112 are shown (e.g., second cable retention channels).

The lead cable clip section 102 may be coupled or integrated with the secondary cable clip section 104 by having coupling elements therebetween. As shown in FIG. 2B, the lead cable clip section 102 and the secondary cable clip section 104 are coupled together by a center coupling member 114 and two lateral coupling members 116. While the two lateral coupling members 116 are from a portion of the lead cable clip section 102 coupling with a portion of the secondary cable clip section 104, an elongate member may be used, such as shown for the center coupling member 114. The lateral coupling members 116 may alternatively or additionally include portions of the lead cable clip section 102 and the secondary cable clip section 104 that are fused together, adhered together, or otherwise coupled together.

The lead cable retention channels 110 may include curved arms 111 (e.g., C-shaped, curved first arms) that help form the shape of the lead cable retention channels 110. Similarly, the secondary cable retention channels 112 may also include curved arms 113 (e.g., C-shaped, curved second arms) that help form the shape of the secondary cable retention channels 112. Also, a branched separator arm 115 may be placed between adjacent secondary cable retention channels 112, such that each arm of the branch forms part of the adjacent secondary cable retention channels 112.

As illustrated, the lead cable retention channels 110 are opened in a first direction, and the secondary cable retention channels 112 are opened in a second direction that is the opposite of the first direction. As such, lead cables are pushed into the lead cable retention channels 110 in a first pushing direction and secondary cables are pushed into the secondary cable retention channels 112 in the opposite pushing direction, wherein the first pushing direction and opposite pushing direction are oriented toward each other. Thus, the lead cable retention channels 110 include an opening 118 (e.g., first inlet region), which also includes the individual lead cable channel openings 118a and 118b (e.g., first inlet opening). The secondary cable channel openings 117 are oriented away from the lead cable channel openings 118a and 118b.

Additionally, individual cables may be held in place with respect to a support structure in any suitable or possible manner, such as via a messenger cable, a pile cable clip, or the like, which may couple with the lead cables. The cable retention clip 100 may then be coupled with the lead cables by fitting the lead cables into the lead cable retention channels 110. This exposes the secondary cable retention channels 112 for receiving the secondary cables therein.

As illustrated, the one or more lead cable retention channels 110 are provided. In this way, the lead cables may be detachably secured with respect to a support structure (e.g., bracket, H-pile), and then the cable retention clip 100 is mounted to these lead cables that are detachably secured to the support structure. The open secondary cable retention channels 112 are then available for receiving the secondary cable wires. This allows for the cable retention clip 100 to quickly couple the lead cable wires together, and to also couple the secondary cable wires to the secured lead cable wires. This configuration and the cable retention clip 100 thereby allows for easy installation of cables, removal of cables, and repair of cables or other components. Moreover, securing the two different types of cables together in this manner ensures orderly cable management, thereby avoiding damage and entanglement—particularly in the case where the panels/bracket are moveable, such as in a solar tracker application. The cable retention clips help organize the solar cables, which may help in installation and repairs or upgrades.

As illustrated, the lead cable clip section 102 of cable retention clip 100 has two lead cable retention channels 110 (i.e., 110a, 110b) but may more generally have one or more lead cable retention channels 110. As is shown in the example, each lead cable retention channel 110 provides a cable receiving portion having a suitable shape—here a ‘C’ shape or partial ring or partial annulus—so as to receive and retain in a detachable or releasable manner a corresponding cable. Each lead cable retention channel 110 includes an adequate cable opening 118a-b, with a main opening designated generally as cable opening 118, to detachably receive and “clamp” a corresponding cable. The size (e.g., the diameter, circumference, cross-sectional area, etc.) of a given retention channel will depend on the size of the outer circumference of a given cable (typically dictated by the gauge of the cable). Similarly, the dimensions of a given retention channel opening 118a-b is such so as to receive the cable in a manner to adequately retain it, and yet allow its removal if needed. The retention ability may be enhanced depending on the material used for the lead cable clip section 102. For example, the lead cable clip section 102 may include a cable clip body made of a resilient plastic material or the like that enables a “clip” effect, so as to allow some expansion of the channel opening 118a-b to accommodate insertion of the cable, such as lead cable, by way of a pressing force on the cable into the retention channel opening 118. Once the cable is inserted, the lead cable retention channel 110 may slightly retract to its original shape, thereby retaining the cable within a given lead cable retention channel 110. In addition, the flexibility of the outer surface of a given cable may also be utilized to facilitate insertion and detachable retention within a given retention channel—e.g., the outer surface, such as deformable plastic, contracts slightly to allow insertion via a channel opening and, once inserted, slight expansion allows the cable to be resiliently and detachably retained within the channel.

Positioned between each lead cable retention channel 110 is a cable separator portion 119. The cable separator portion maintains adequate separation between adjacent cables, further ensuring against inadvertent shorts, for example.

The secondary cable clip section 104 may include the secondary cable retention channels 112 that are configured as described for the lead cable retention channels 110. The secondary cable retention channels 112 may be smaller than the lead cable retention channels 110, but may include the same or similar “C” shape (or a different shape) and the flexibility for opening and retaining the secondary cables therein.

In example embodiments, the cable retention clip 100 comprises a plastic material, and may exhibit resilient properties to enhance engagement with the cables as discussed above. In some embodiments, the cable retention clip 100 is non-conductive, which may be advantageous in the event of an electrical short in a cable, for example. In embodiments, the material(s) used are also resilient to severe environmental conditions (cold, heat, humidity, UV exposure), so as to be able to withstand varying environmental conditions present in a typical solar installation The body of the cable retention clip 100 may include both sections (e.g., 102, 104) being formed of a same resiliently deformable material, wherein the material is selected from a metal coated with an insulation layer, a non-conducting plastic, or combinations thereof.

While the embodiment of the cable retention clip 100 described above illustrates an implementation with channels (e.g., 110) that provide support and alignment of two equally sized (gauges) of cable, it will be appreciated that embodiments could be provided that support more than two cables, and/or that provide support for cables of different sizes (gauges). Also, the smaller cable retention channels (e.g., 112) may be configured in size to accommodate specifically sized solar cables, and the number of secondary cable channels may be varied.

In some embodiments, a cable retention clip is provided. The cable retention clip may include a first body portion and a second body portion. The first body portion may be shaped to define at least a pair of first cable retention channels that are positioned adjacent with each other. Each first cable retention channel has a parallel channel axis, which is parallel with each other. Each first cable retention channel includes a first inlet opening extending a length of each first cable retention channel. The first body portion has a first base side that is opposite of each first inlet opening. The second body portion may define multiple second cable retention channels that are positioned adjacent with each other. Each second cable retention channel has a parallel channel axis with respect to the other second cable retention channels. A second inlet opening is formed in each second cable retention channel that extends a length of each second cable retention channel. The second body portion has a second base side opposite of each second inlet opening. The first base side of the first body portion is coupled to the second base side of the second body portion such that each first inlet opening opens in a direction opposite of each second inlet opening. The coupling may be by any joining, such as by being adhered together, welded or brazed, or integrated by being formed of the same material. Injection molding may be used to form the first body and second body joined together or other suitable process.

In some embodiments, the cable retention clip may have each first inlet opening of each first cable retention channel being opened to form a first common inlet opening region for the pair of first cable retention channels. Also, there may be at least a pair of second cable retention channels that have second inlet openings that form a second common inlet opening region for that pair of second cable retention channels.

In some embodiments, the cable retention clip may include a first body portion (e.g., 102) that is a planar body and the second body portion (e.g., 104) is a planar body. The first planar body and second planar body may be on a common plane. Also, the pair of first cable retention channels may be parallel with the second cable retention channels.

In some embodiments, the cable retention clip is characterized by at least one of: the length of each first cable retention channel is longer than the length of each second cable retention channel; a diameter of each first cable retention channel is larger than a diameter of each second cable retention channel; a thickness of the first body portion is thicker than a thickness of the second body portion; the second cable retention channels are aligned in a row; or there is at least one second cable retention channel for each first cable retention channel.

In some embodiments, the cable retention clip may include the first body being formed by at least two connected C-shaped arms connected together at a first cable separator portion or separating region (e.g., 119) of the first body that is positioned at least partially between the pair of first cable retention channels. This may form a [symbol] shape (e.g., lowercase omega shape) in some embodiments. In some aspects, the second body is formed by multiple connected C-shaped arms that are connected together at a second cable separator portion or separating region (e.g., 115) of the second body that is positioned at least partially between a pair of the second cable retention channels. In some aspects, the first body and second body are formed of a same resiliently deformable material, wherein the material is selected from a metal coated with an insulation layer, a non-conducting plastic, or combinations thereof. At least two of the channels may be in a pair with the [symbol] shape. Medial channels may include an arm of a branched separator forming the C shape.

In some embodiments, the cable retention clip may be configured as follows with the first body (e.g., 102) and the second body (e.g., 104). The first body may define a pair of first cable retention channels that are positioned adjacent to each other. Each first cable retention channel is dimensioned to retain a lead cable therein. Each first cable retention channel may be formed by a curved first arm extending from a separating region of the first body that is at least partially between the pair of first cable retention channels. Each curved first arm may form a first cable channel opening by having a first channel gap between an end of the curved first arm and an end of the separating region. Also, a common gap is between each curved first arm end that forms a first inlet region for both of the first cable retention channels in the pair. The second body portion may define multiple second cable retention channels that are positioned adjacent to each other. Each second cable retention channel is dimensioned smaller than each first cable retention channel. Each second cable retention channel is formed by a curved second arm extending from an adjacent curved second arm. In some aspects, the second cable retention channels are formed such that each curved second arm forms a second cable channel opening by a second channel gap being between an end of the curved second arm and an end of a second separating region being at least partially between adjacent second retention channels. Also, a second common gap is between at least one pair of curved second arm ends that forms a second inlet region for both of the second cable retention channels in the pair.

In some embodiments, the cable retention clip may include a first body that is coupled to the second body portion with at least one of the following: an elongate member (114) forming a connection between the first body and second body; or a joining of a material of the first body and the second body to integrate (e.g., 116) the first body and second body.

In some embodiments, the cable retention clip may include three second cable retention channels for each first cable retention channel. The three second cable retention channels are located under and linked to the respective first cable retention channel.

In some embodiments, the cable retention clip may have various configurations. In some aspects, the pair of first cable retention channels forms a [symbol] shape. In some aspects, at least two pairs of second cable retention channels both form a [symbol] shape. In some aspects, a center separating region is between the two sets of three second cable retention channels and forms a branch with each branch arm pointing in opposite directions. In some aspects, there is a curved separating member (e.g., 113) between each pair of second cable retention channels and adjacent second cable retention channel of each set. In some aspects, the openings of each [symbol] shape of the first cable retention channels open away from openings of each [symbol] shape of the second cable retention channels.

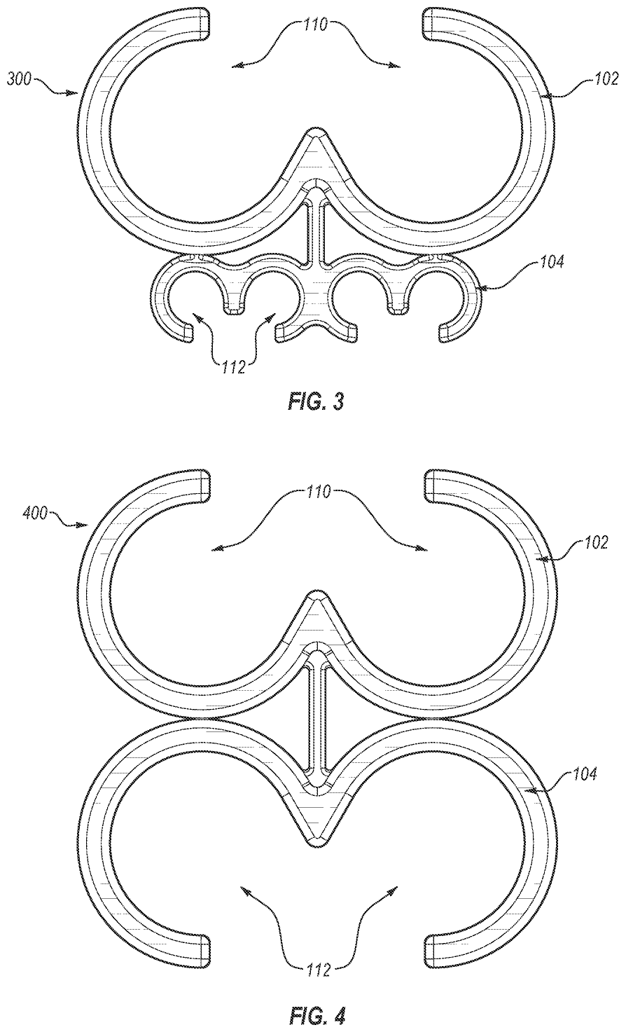

FIG. 3 shows a front view of a cable retention clip 300 that includes two lead cable retention channels 110 and four secondary cable retention channels 112. Other than the number of secondary cable retention channels 112, the cable retention clip 300 includes the same or similar features of the cable retention clip 100 of FIGS. 2A-2E.

FIG. 4 shows a front view of a cable retention clip 400 that includes two lead cable retention channels 110 and two secondary cable retention channels 112. However, it should be noted that these two secondary cable retention channels 112 may be configured to be the same dimension and/or configuration as the lead cable retention channels 110, and thereby the cable retention clip 400 may hold four lead cables. However, the secondary cable retention channels 112 may be smaller as shown in FIGS. 3. Other than the number of secondary cable retention channels 112, the cable retention clip 400 includes the same or similar features of the cable retention clip 100 of FIGS. 2A-2E.

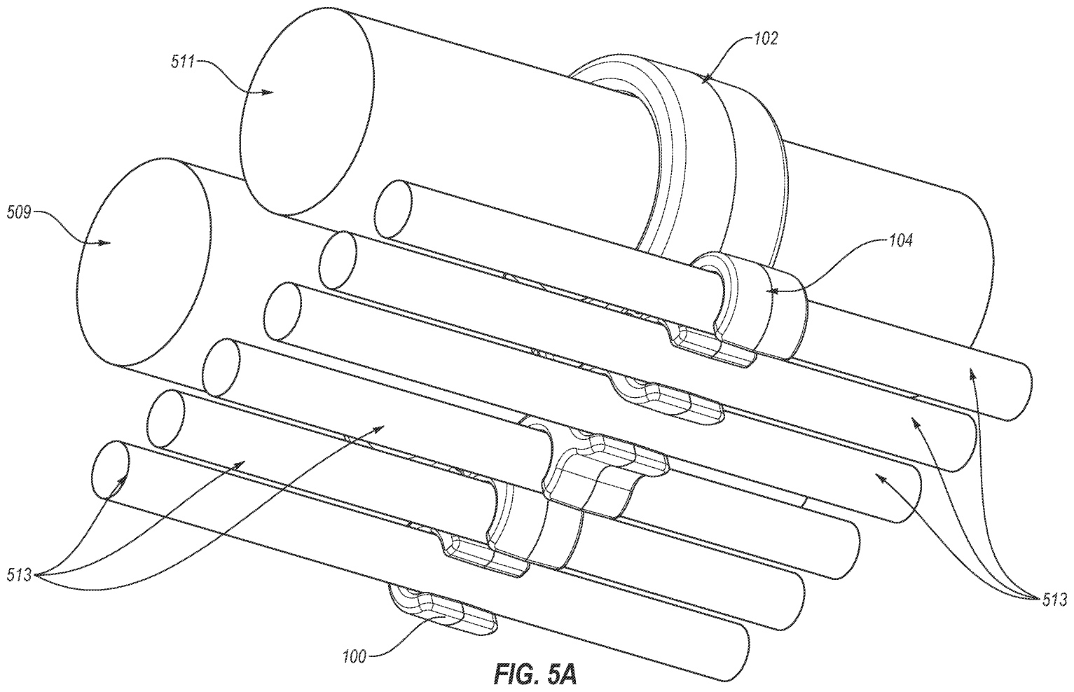

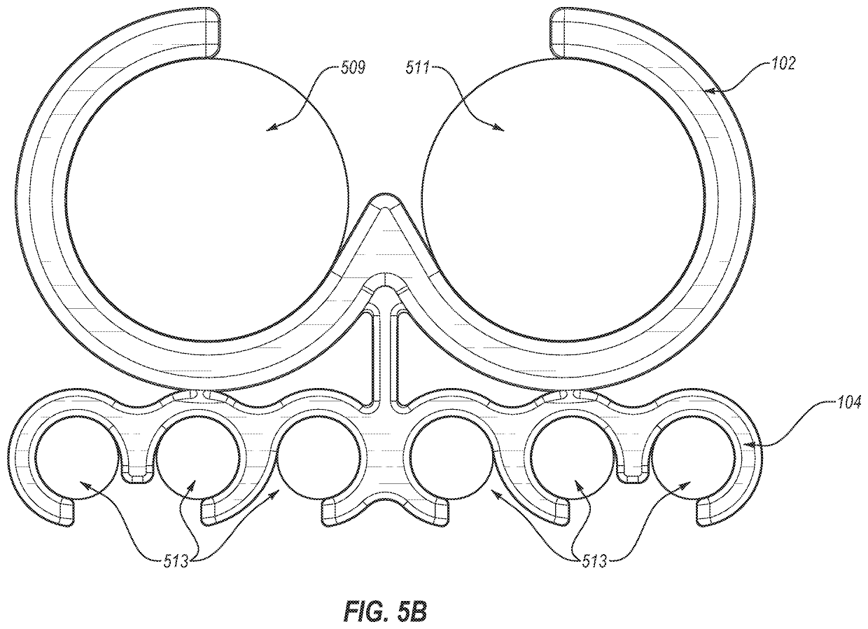

FIGS. 5A-5B shows the cable retention clip 100 being coupled with two lead cables 509 and 511 and six secondary cables 513. The configuration of the cable retention clip 100 allows for the secondary cables 513 to be mounted to the first and second lead cables 509 and 511. The first and second lead cables 509, 511 may include, be included in, or correspond to the first and second BLA cables 9, 11 (e.g., positive and negative lead cables) of FIG. 1. In this example, there are three secondary cables 513 that are associated with the first lead cable 509 (e.g., positive) and there are three secondary cables 513 that are associated with the second lead cable 511 (e.g., negative).

The orientation of the channel openings allows for the two lead cables 509 and 511 to be vertically oriented with respect to each other, horizontally oriented with respect to each other, or oriented with respect to each other at any other angle. Depending on the orientation, the secondary cables 513 may be horizontally positioned relative to the lead cables 509, 511, or the secondary cables 513 may be over the lead cables 509, 511, or the secondary cables 513 may be under the lead cables 509, 511, or the secondary cables 513 may have some other orientation with respect to the lead cables 509, 511. While FIG. 5A shows a perspective view, FIG. 5B shows a side view with cross-sections of the cables 509, 511, 513, which show the secondary cables 513 hanging under the two lead cables 509, 511; however, the relative orientation may be switched by rotating the cable retention clip 100 at any angle, such as 45, 90 or 180 degrees.

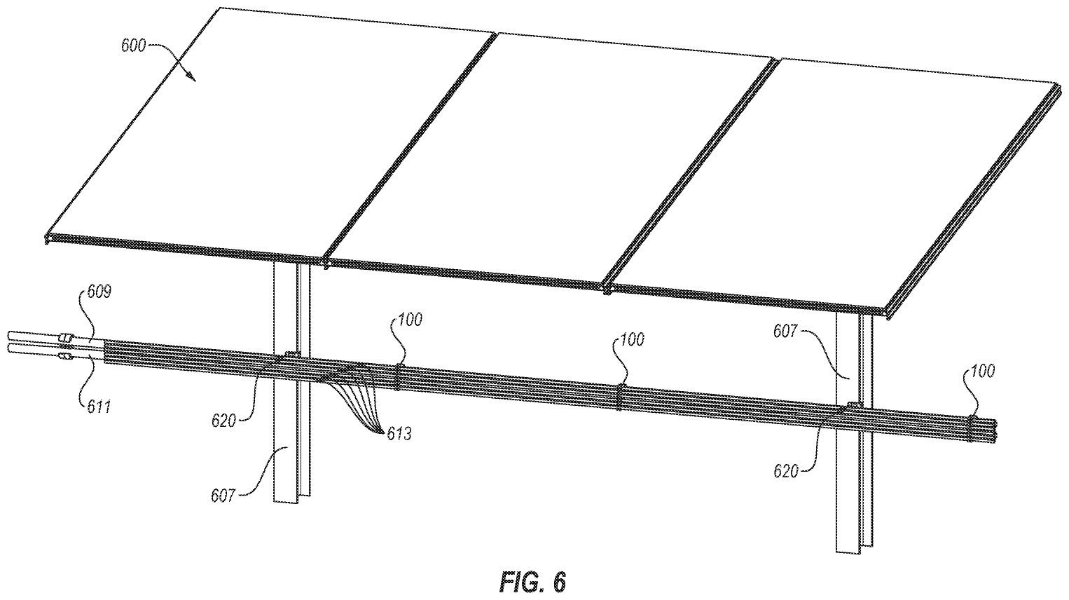

FIG. 6 shows a solar panel array 600 mounted on a support structure that includes piles 607, the support structure secured in the ground. Attached to each pile 607 is a cable clip 620 that clips onto the pile 607 and onto two BLA lead cables 609, 611. The BLA lead cables 609, 611 may include, be included in, or correspond to the first and second BLA cables 9, 11 (e.g., positive and negative lead cables) of FIG. 1. Additionally, the cable retention clip 100 is mounted to the two BLA lead cables 609, 611 in its lead cable retention channels 110. Also, there are six secondary cables 613 mounted into the secondary cable retention channels 112 of the cable retention clip 100.

In another embodiments, a mounting bracket may be used to support a PV solar panel (not shown) via a clamp, rail, H-pile, I-beam, cross-beam, and/or other combinations of structural components as well as PV components. As is known, electrical power generated by a PV solar panel in the form of direct current (DC) generated by a solar panel is conducted to combiner boxes, inverters and the like (not shown) by way of one or more cables. Depending on the nature of the solar installation, there may be a large number of PV solar panels, resulting in a large number of cables. Thus, in a typical installation, many cables need to be oriented, routed and managed.

Further management of the cables may be provided by way of one or more cable retention clips 100. In the example shown, the cable retention clips 100 retain lead cables 609, 611 in a substantially parallel and detachable manner, further ensuring organization of the cables relative to each other and the support structure. Again, this maintains cable management and organization by reducing the opportunity for entanglement, and highly organizing the cables. The cable retention clips 100 also retain the secondary cables 613.

In some embodiments, the solar infrastructure may include a cable retention system that omits at least one messenger cable that is merely structural without electrical transmission. In some aspects, the messenger cable 3 of FIG. 1 may be replaced by one of the first BLA cable 9 or the second BLA cable 11 that is mounted to the pile 7, and then the other of the first BLA cable 9 and the second BLA cable 11 is supported by the mounted BLA cable, e.g., through one or more cable retention clips 100. Also, the cable retention clips 100 may be used to couple the secondary cables to the lead cables.

Energy is harvested by the solar panels and is passed to junction boxes, where wire harnesses may be used. The solar energy installation may also include recombiner boxes, inverters (DC to AC), transformers, and a switch yard. Each solar panel is connected to a junction box, which may be integrated or separate. Each junction box may be in communication with one branch of a wire harness, typically with 6-12 branches, and 12 branches per wire harness being preferred. Each wire harness has one trunk, which is in communication with a recombiner box. For example, a harness may include multiple branches feeding into one trunk BLA cable. The branches may be constructed of 10 or 12 gauge wire cable, and the BLA cables may be constructed of 10 or 8 gauge wire cables. One trunk BLA cable may provide electricity in one direction and one trunk BLA cable may provide electricity in the other direction.

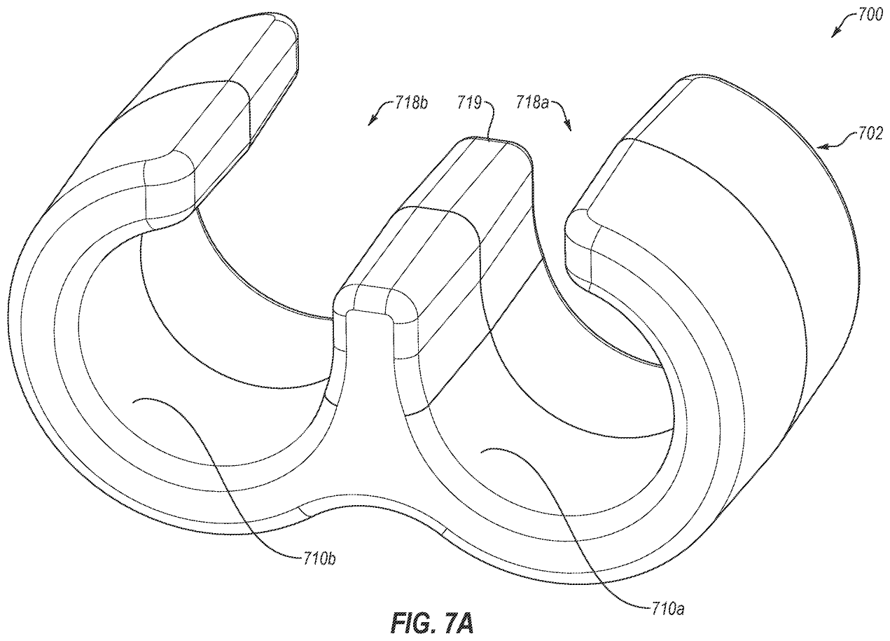

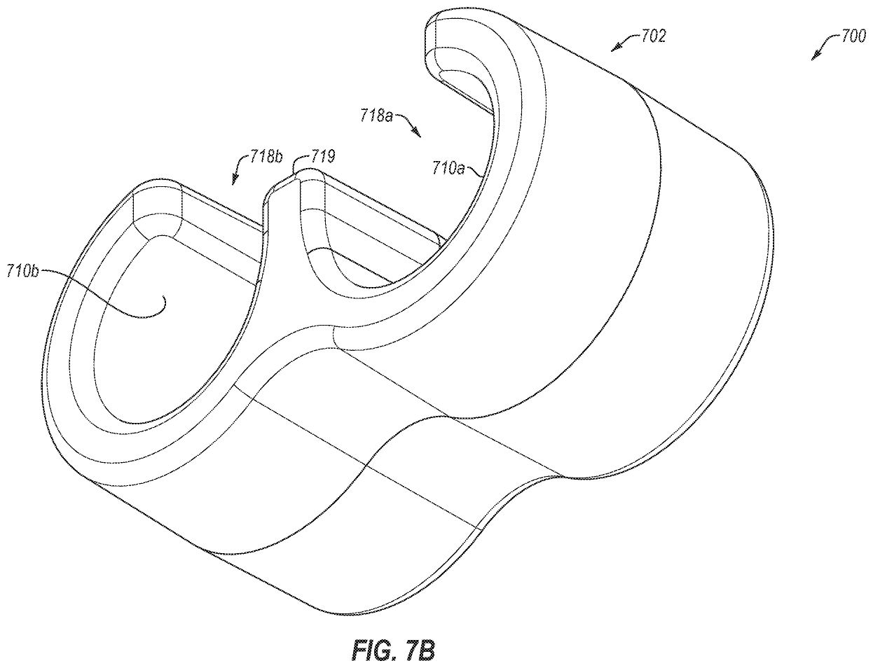

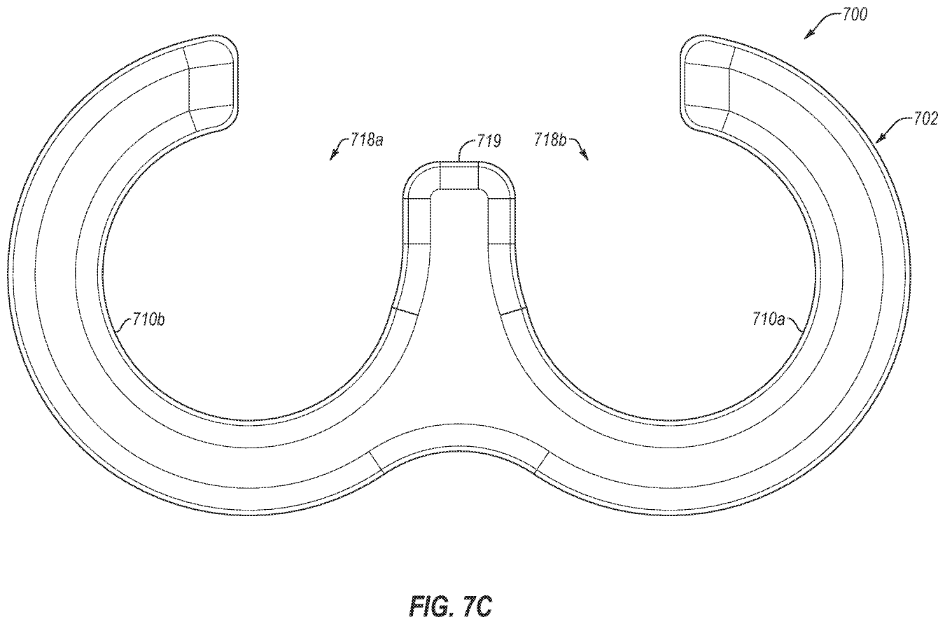

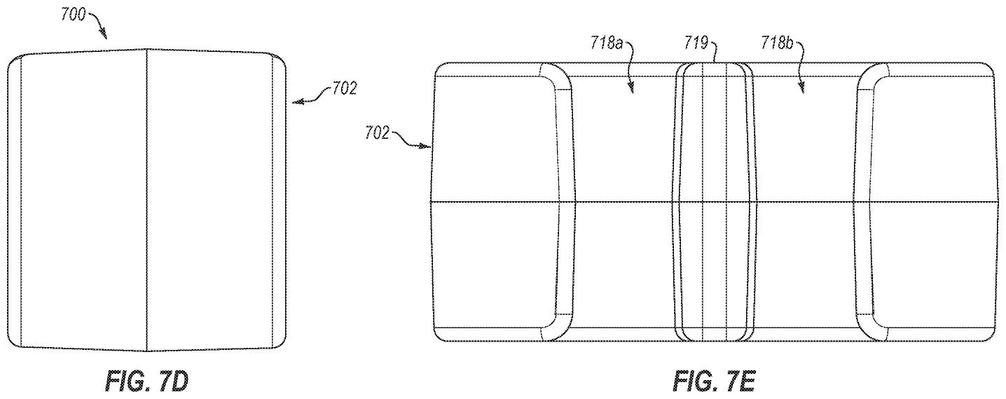

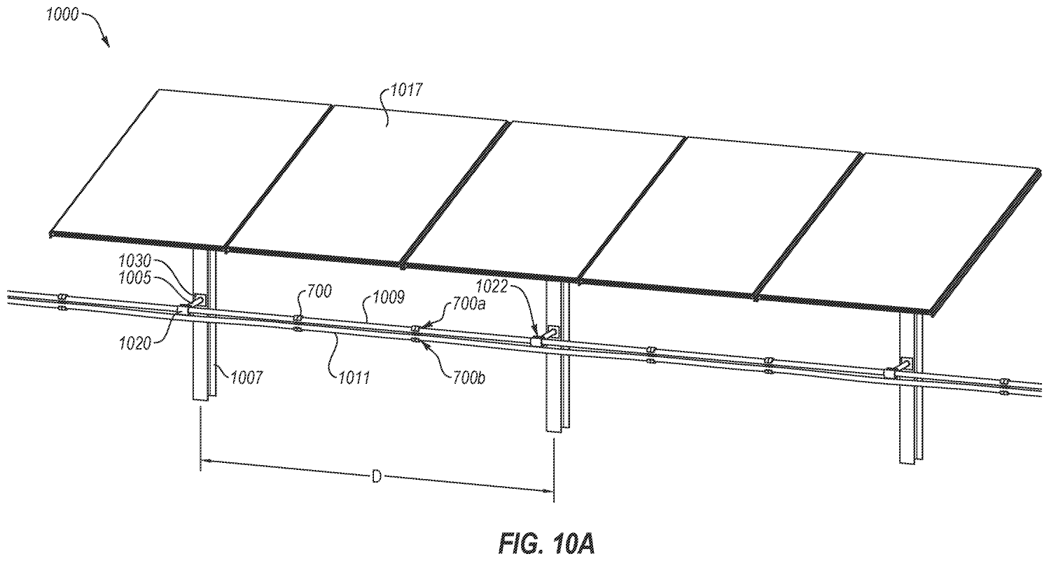

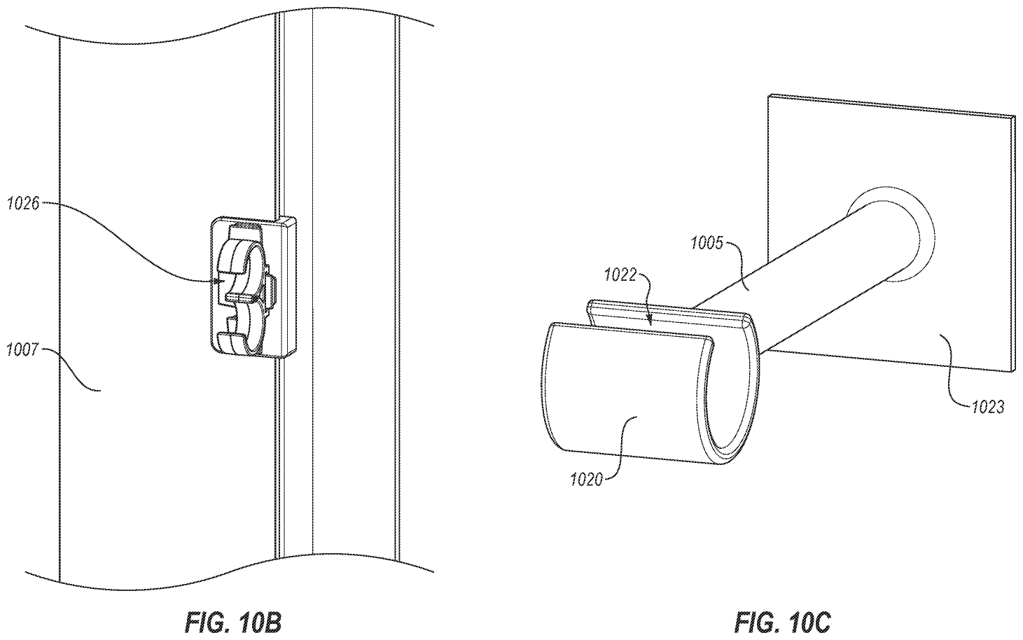

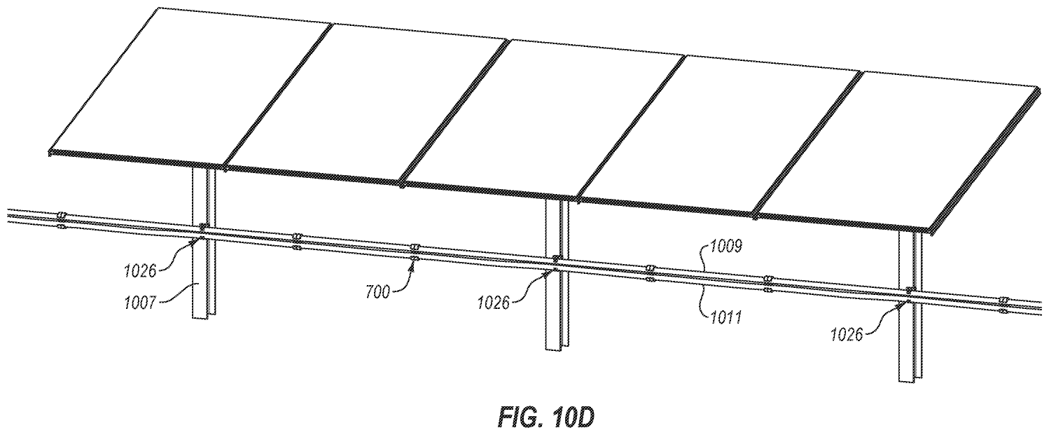

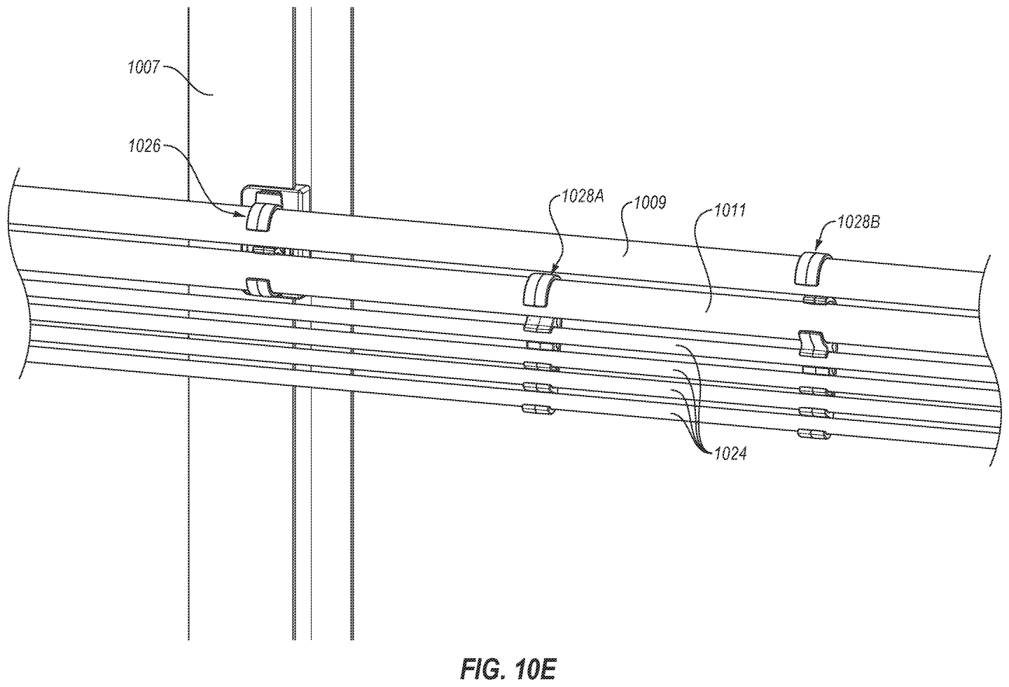

FIGS. 7A-7E illustrate an embodiment of a solar cable retention clip 700 that retains two solar cables together. The cable retention clip 700 may be used in the cable management system so as to maintain connection and grouping between selected pairs (or more) of cables, such as cables 1009, 1011 of FIG. 10A. As with the cable retention clip 100, the example cable retention clip 700 includes a clip body portion, denoted at 702, defining one or more clip cable retention channels, two of which are shown in the example at 710a and 710b (collectively “cable retention channels 710”). The cable retention channels 710 may be separated by a cable separator portion 719.

As is shown in the example of FIG. 7A, each cable retention channel 710 provides a clip cable receiving portion having a suitable shape—here a ‘C’ shape — so as to receive and retain in a detachable manner a corresponding cable. Each cable retention channel 710 includes an adequate opening, denoted here at 718a and 718b (collectively “channel openings 718”) to detachably receive and “clamp” a corresponding cable. The size (e.g., the diameter, etc.) of a given cable retention channel 710 may depend on the size of the outer circumference of a given cable (or gauge of the cable). Similarly, the dimensions of a given channel opening 718 is such so as to receive the cable in a manner to adequately retain it, and yet allow its removal if needed. The retention ability may be enhanced depending on the material used for the cable clip 700. For example, a resilient plastic material or the like enables a “clip” effect, so as to allow some expansion of the channel opening to accommodate insertion of the cable by way of a pressing force on the cable into the clip retention channel opening. Once the cable is inserted, the retention channel may slightly retract to its original shape, thereby retaining the cable within a given retention channel. In addition, the flexibility of the outer surface of a given cable may also be utilized to facilitate insertion and detachable retention within a given retention channel, such as the outer surface, with deformable plastic, which contracts slightly to allow insertion via a clip channel opening and, once inserted, slight expansion allows the cable to be resiliently and detachably retained within the channel. As with the retention clip, the cable clip may utilize rounded surfaces in areas that may come into contact with a cable, so as to avoid any damage to the cable during insertion or retraction.

FIGS. 7B and 7C show additional views of the example cable clip 700. FIG. 7D shows a side elevation view, and 7E a top view. Cable clip 700 may be formed as a single integral piece in some embodiments. Optionally, the cable clip 700 may be formed from one or more pieces that are then attached. In example embodiments, the cable clip 700 comprises a plastic material, and may exhibit resilient properties to enhance engagement with the cables as discussed above. In some embodiments, the cable clip is non-conductive, which may be advantageous in the event of an electrical short in a cable, for example. In embodiments, the material(s) used are also resistant to severe environmental conditions (cold, heat, humidity), so as to be able to withstand varying weather conditions present in a typical solar installation.

While the embodiment of the cable clip 700 described above illustrates an implementation that provides support and alignment of two equally sized (gauges) of cable, it will be appreciated that embodiments could be provided that support more than two cables, and/or that provide support for cables of different sizes (gauges).

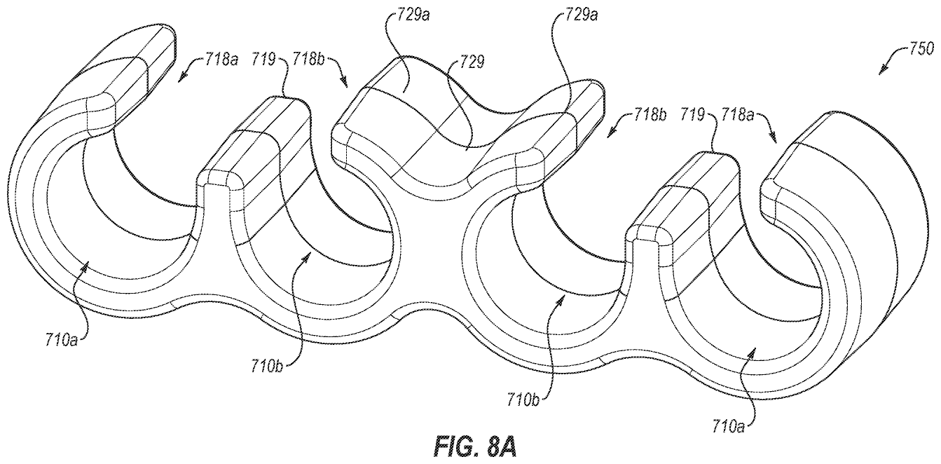

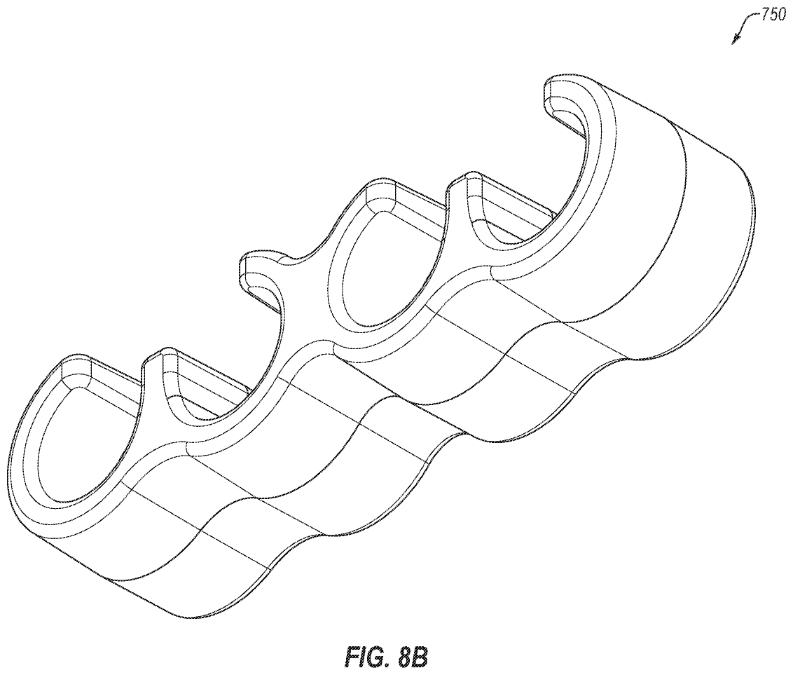

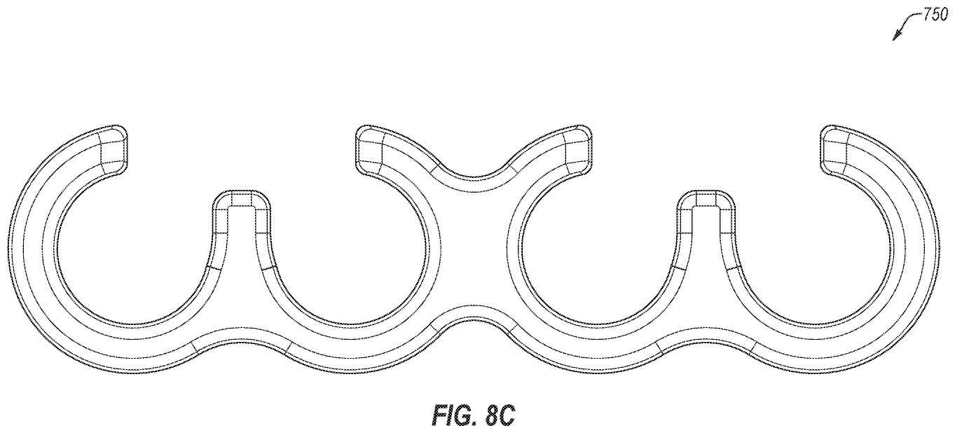

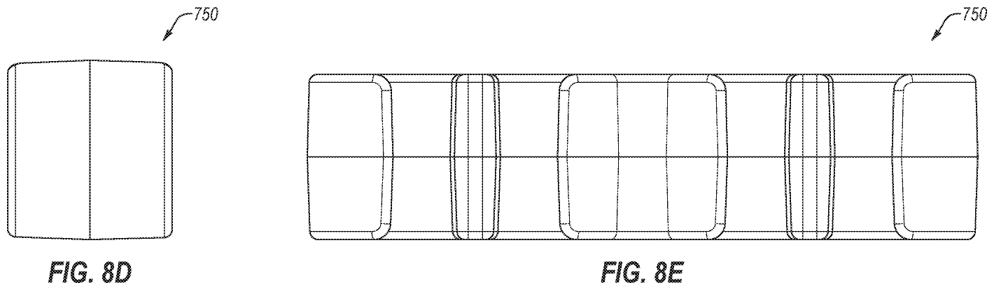

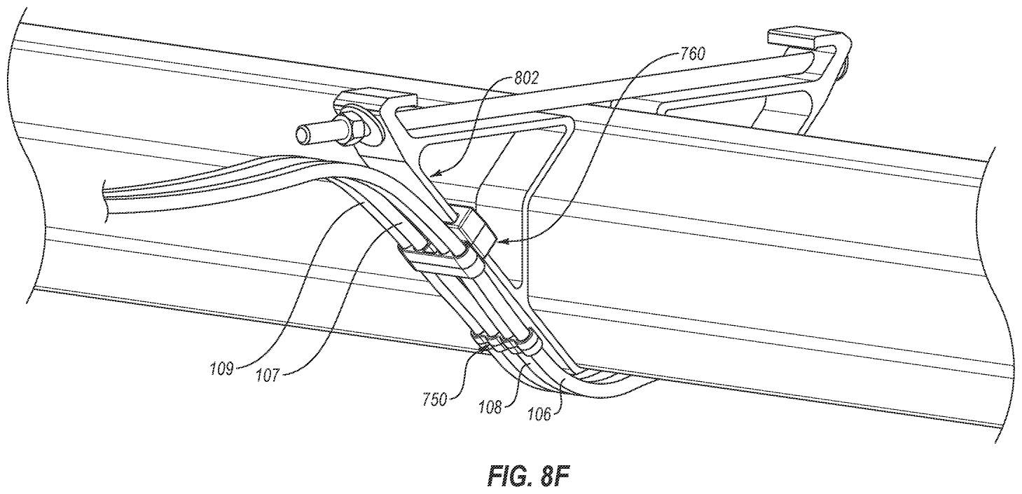

FIGS. 8A-8E illustrate another example of a solar cable retention clip 750. The cable clip 750 is similar to the cable clip 700, except that additional clip cable retention channels are provided—here a total of four. It will be appreciated that any number of cable retention channels may be provided based on the needs of a given application. Details regarding the cable clip 750 are shown in FIGS. 8A-8E, all of which are similar to those already described in connection with the cable clip 700 of FIGS. 7A-7E, and will not be repeated here. Additionally, the cable clip 750 may include two pairs of channels, which channels are laterally arranged around a center separating member 729. The separating member 729 may include two wings 729a for the members of the pair of channels. The two wings 729a help form the shape of the inner channels 710b.

FIG. 8F illustrates a solar installation having a support structure (e.g., beam) having a bracket 802 mounted thereto. The bracket 802 receives a cable retention clip 760 that is configured to clamp onto the bracket 102 and receive solar cables 106, 107, 108, and 109 in cable channels. The solar cable retention clip 750 is shown to clip to and organize the solar cables 106, 107, 108, and 109 in an aligned and parallel organization.

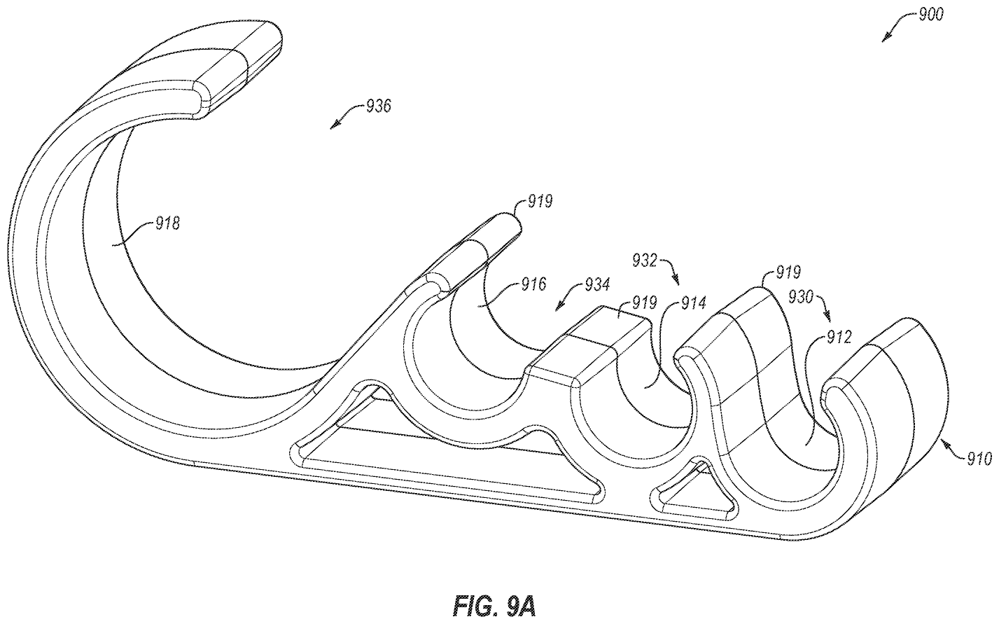

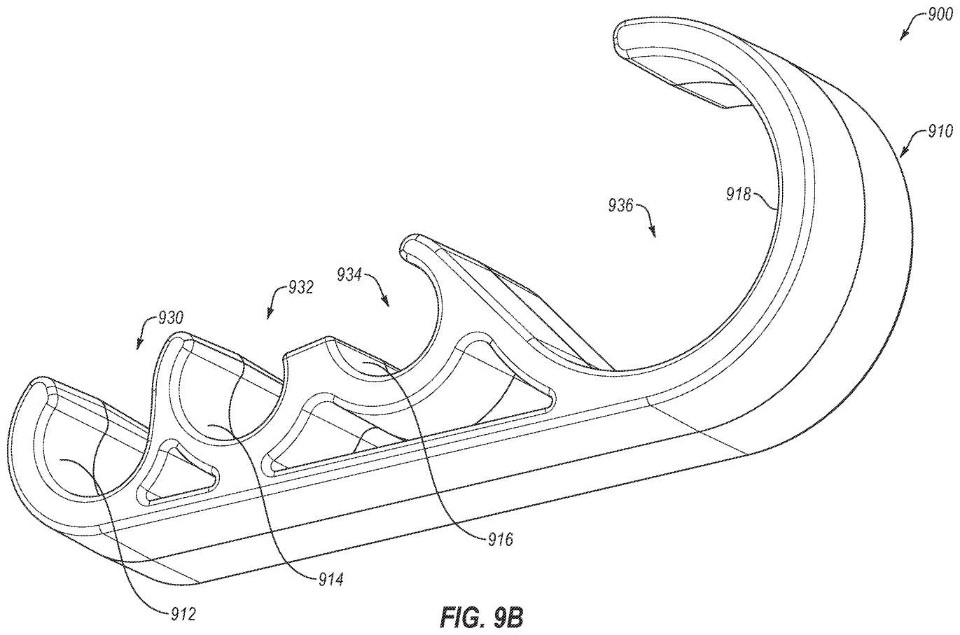

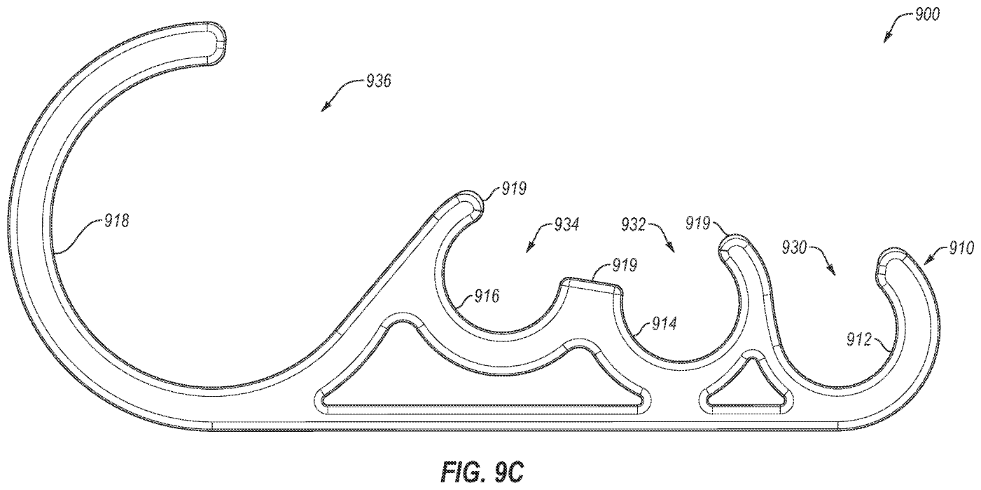

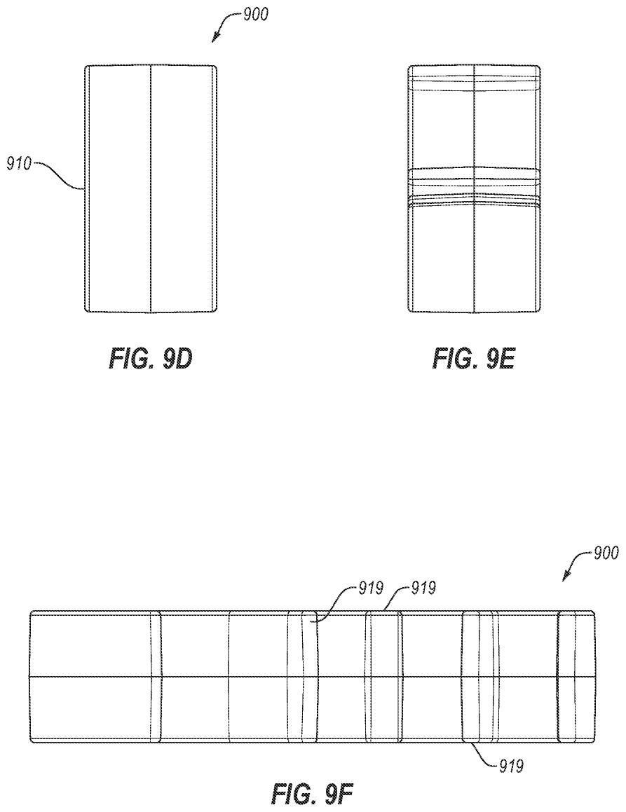

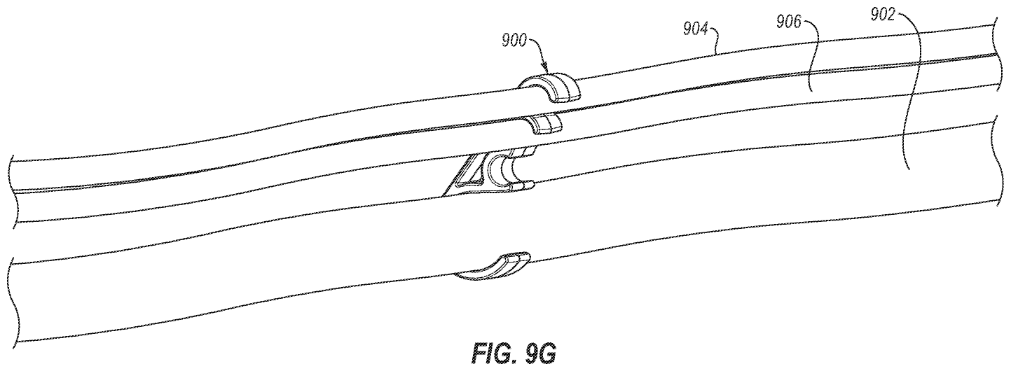

FIGS. 9A-9F illustrate another embodiment of a solar cable retention clip 900. Specifically, FIG. 9A illustrates a cable clip, denoted at 900, that is configured to have four cables, with at least one of the cables having a larger outer diameter (gauge) than the other cables. Of course, other combinations of sizes and cable numbers could be provided. As with the cable clips 700 and 750 described previously, the cable clip 900 includes a clip body portion, denoted at 910, defining one or more clip cable retention channels, four of which are shown in the example at 912, 914, 916 and 918. Each channel 912, 914, 916 and 918 is separated by a cable separator portion, denoted here at 919. Each clip retention channel provides a clip cable receiving portion having a suitable shape—here a ‘C’ shape—so as to receive and retain in a detachable manner a corresponding cable, which may be configured similarly to the other cable channels of the other embodiments of the solar cable retention clips provided herein. Each clip retention channel includes an adequate opening, denoted here at 930, 932, 934 and 936 to detachably receive and “clamp” a corresponding cable. The size (e.g., the diameter) of a given clip retention channel will depend on the size of the outer circumference of a given cable (or gauge of the cable). Similarly, the dimensions of a given clip retention channel opening 930, 932, 934 and 936 is such so as to receive the cable in a manner to adequately retain it, and yet allow its removal if needed. For example, cable channel 918 may have a cable channel opening 936 dimensioned for a BLA cable, and the other cable channels 912, 914, and 916 include openings 930, 932, and 934, respectively, that are dimensioned for smaller secondary solar cables.

The cable retention clip 900 may be formed as a single integral piece in some embodiments. Optionally, the cable clip 900 may be formed from one or more pieces that are then attached. In example embodiments, the cable clip 900 comprises a plastic material, and may exhibit resilient properties to enhance engagement with the cables as discussed above. In some embodiments, the cable clip (as is the case with all of the embodiments described herein) is non-conductive, which may be advantageous in the event of an electrical short in a cable, for example. In embodiments, the material(s) used are also resistant to severe environmental conditions (cold, heat, humidity), so as to be able to withstand varying weather conditions present in a typical solar installation.

FIG. 9G shows the cable retention clip 900 coupled to a BLA cable 902 and to two secondary solar cables 904 and 906. In FIG. 9G, the cable retention clip 900 also has an open cable channel to receive and couple to a third secondary solar cable (not shown). The third secondary solar cable could be added to the open cable channel if needed or desired.

FIG. 10A shows a solar installation 1000 having solar panels 1017 mounted to piles 1007, which solar installation is devoid of a messenger cable or any other dedicated support cable (e.g., wire or cable not transmitting electricity) between adjacent piles 1007. Now, the first BLA cable 1009 may be mounted to the pile 1007 and support the other second BLA cable 1011. As shown, the pile 1007 includes or has attached thereto a hanger arm 1005 on a mount 1030 that is mounted thereto. The hanger arm 1005 is outfitted with a cable clip 1020 having at least one cable channel 1022. The cable clip 700 holding cables 1009, 1011 may be configured as described herein. The cable channel 1022 holds the first BLA cable 1009 therein. Additionally, cable clips 700 are shown to couple the second BLA cable 1011 to the first BLA cable 1009. Here, the first BLA cable 1009 is coupled with one cable channel 700a of the cable clip 700 and the second BLA cable 1011 is coupled with the other cable channel 700b of the cable clip 700.

Accordingly, FIG. 10A. illustrates an embodiment where there is no messenger cable and only one of the BLA cables is coupled to the pile 1007 without any intervening cables through the hanger arm 1005. The second BLA cable 1011 is not coupled to the pile 1007 as directly as the second BLA cable 1011. Instead, the second BLA cable 1011 is coupled directly to the first BLA cable 1009 via the cable clip 700. The sequentially adjacent piles 1007 may be a dimension apart from each other to create a span of BLA cable supporting itself and the other BLA cable and any other secondary cables.

FIG. 10B shows an alternative BLA mounting bracket 1026, which is shown to be mounted to an H-pile 1007. This BLA mounting bracket 1026 mounts both BLA cables to the H-pile 1007. A two channel BLA mounting clip may be adapted to be coupled with any type of pile, whether round, polygon, H, or the like.

FIG. 10C shows a BLA mounting bracket 1023 having a hanger arm 1005 with a single channel cable clip 1020. The single channel cable clip 1020 only includes a single channel 1022 for coupling with a single BLA cable. However, the cable clip 1020 may include two BLA cable channels in other embodiments.

FIG. 10D shows the BLA mounting bracket 1026 mounted to the H-pile 1007 to retain BLA cables 1009, 1011. The solar cable retention clip 700 is shown to keep the two BLA cables 1009, 1011 organized in an aligned matter so that they extend substantially parallel to each other. This configuration elevates the two BLA cables 1009, 1011 above ground, and provides them in an organized and neat arrangement.

FIG. 10E shows the BLA mounting bracket 1026 mounted to the H-pile 1007 to retain two BLA cables 1009, 1011. As shown, there is no messenger cable and both of the BLA cables 1009, 1011 are coupled to the pile 1007, through a direct coupling, such as the BLA mounting bracket 1026. Alternatively, the BLA cables 1009, 1011 may be directly coupled to the pile 1007 through some other arrangement, such as the cable clip 1020, hangar arm 1005, and BLA mounting bracket 1023 of FIG. 10C. As illustrated in FIG. 10E, the first BLA cable 1009 is coupled to the mounting bracket 1026 that is coupled with the pile 1007. The second BLA cable 1011 is also coupled to the mounting bracket 1026 that is coupled to the pile 1007. The second BLA cable 1011 is coupled directly to the same mounting bracket 1026 that is coupled with the first BLA cable 1009. Additionally, a cable clip 1028A and/or a cable clip 1028B (collectively “cable clips 1028”) may be used to couple secondary cables 1024 to one or both of the BLA cables 1009, 1011. The cable clips 1028 may be similar in many respects to the cable clip 900 except as indicated. In particular, each of the cable clips 1028 includes four secondary cable retention channels, whereas the cable clip 900 include three secondary cable retention channels 912, 914, 916. In addition, the cable clip 1028B includes two BLA cable retention channels, whereas the cable clip 900 includes one BLA cable retention channel 918.

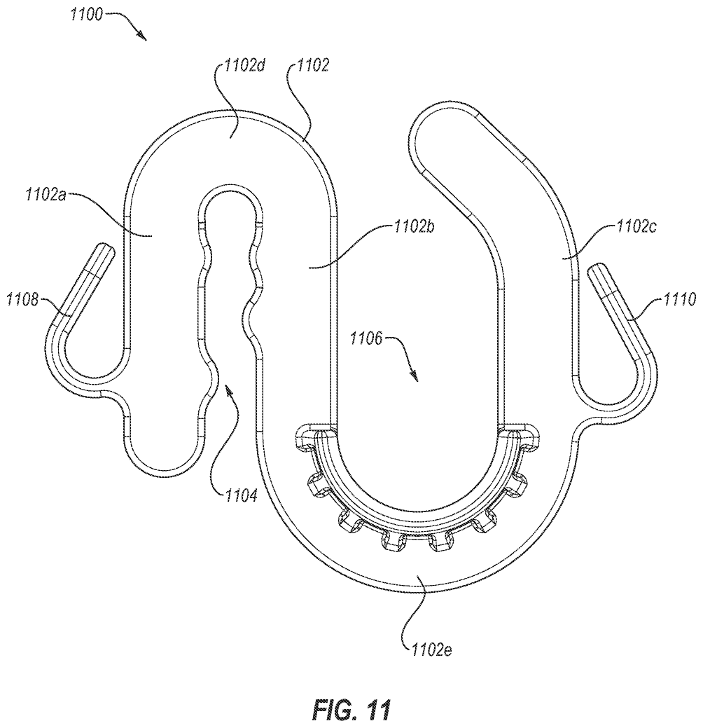

FIG. 11 shows the cable hanger 21 of FIG. 1, which is labeled cable hanger 1100 in FIG. 11. Cable hanger 1100 includes a body 1102 formed of a first straight body portion 1102a connected to a second straight body portion 1102b by a first curved portion 1102d, and the second straight body portion 1102b is connected to a third straight body portion 1102c by a second curved portion 1102e. Additionally, a first hook 1108 is included on the first straight body portion 1102a and a second hook 1110 is included on the third straight body portion 1102c. The first hook 1108 and second hook 1110 may be used for coupling other features or secondary cables to the cable hanger 21. As configured, the first straight body portion 1102a and second straight body portion 1102b form a cable channel 1104, which is configured for receiving a messenger cable (e.g., messenger cable 3 of FIG. 1). The cable channel 1104 has protrusion features on the surface that help hold the cable hanger 21 to the messenger cable 3 without slipping or falling off, such as in high winds. The second straight body portion 1102b and third straight body portion 1102c form a solar cable channel 1106, which is configured for holding at least one BLA cable therein. Additional cables may also be located and supported by the solar cable channel 1106. The cable hanger 21 may be used to hang BLA cables, and then the cable retention clips described herein may be used to attach the secondary cables to the hung BLA cables. As such, the cable hanger 21 may be used in the solar installations and solar cable clip systems described herein.

In some embodiments, a cable retention clip is provided. The cable retention clip may include a first body portion and a second body portion. The first body portion may be shaped to define at least a pair of first cable retention channels that are positioned adjacent with each other. Each first cable retention channel has a parallel channel axis, which is parallel with each other. Each first cable retention channel includes a first inlet opening extending a length of each first cable retention channel. The first body portion has a first base side that is opposite of each first inlet opening. The second body portion may define multiple second cable retention channels that are positioned adjacent with each other. Each second cable retention channel has a parallel channel axis with respect to the other second cable retention channels. A second inlet opening is formed in each second cable retention channel that extends a length of each second cable retention channel. The second body portion has a second base side opposite of each second inlet opening. The first base side of the first body portion is coupled to the second base side of the second body portion such that each first inlet opening opens in a direction opposite of each second inlet opening. The coupling may be by any joining, such as by being adhered together, welded or brazed, or integrated by being formed of the same material. Injection molding may be used to form the first body and second body joined together.

In some embodiments, a cable arrangement may include a cable retention clip with a pair of lead cables and multiple secondary cables coupled with the cable retention clip. The pair of lead cables may be configured as solar lead cables. Each lead cable is located in a first cable retention channel. The secondary cables may be configured as solar secondary cables, which are smaller than the lead cables. Each secondary cable located in a second cable retention channel.

In some embodiments, a solar installation may include a cable retention clip, a pair of lead cables, multiple secondary cables, and at least one solar panel. The pair of lead cables may be configured as solar lead cables. Each lead cable is located in a first cable retention channel. The secondary cables may be configured as solar secondary cables. Each secondary cable is located in a second cable retention channel. There is at least one solar panel or array thereof operably coupled with at least one of the lead cables or secondary cables.

A method of hanging solar wire cables may be provided. Such a method may include using the retention clips described herein to couple lead cables to secondary cables for solar cable hanging in above ground solar installations. The method may include taking a lead cable and pressing it into a lead cable retention channel, such that the first body flexes to receive the lead cable, and then retracts to form the channel around the lead cable. That is, a curved arm, such as a C shape, may be flexed laterally to open the channel to receive the cable, and then the curved arm retracts to its normal shape to retain the cable in the channel. The configuration for the channels and arms applies to the first channels and second channels of the cable retention clip.

The terms and words used in this description and claims are not limited to the bibliographical meanings, but, are merely used to enable a clear and consistent understanding of the disclosure. It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors are known to those skilled in the art, may occur in amounts that do not preclude the effect the characteristic was intended to provide.

The present disclosure is not to be limited in terms of the particular embodiments described in this application, which are intended as illustrations of various aspects. Many modifications and variations may be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, compounds, or materials, which can, of course, vary. It is also to be understood that the terminology used herein is for the purpose of describing particular embodiments only and is not intended to be limiting.

Aspects of the present disclosure may be embodied in other forms without departing from its spirit or essential characteristics. The described aspects are to be considered in all respects illustrative and not restrictive. The claimed subject matter is indicated by the appended claims rather than by the foregoing description. All changes which come within the meaning and range of equivalency of the claims are to be embraced within their scope.

1. A cable retention clip comprising:
a first body defining at least a pair of first cable retention channels that are positioned adjacent with each other and each first cable retention channel has a parallel channel axis and a first inlet opening extending a length of each first cable retention channel, the first body portion having a first base side opposite of each first inlet opening; and
a second body defining a plurality of second cable retention channels that are positioned adjacent with each other and each second cable retention channel has a parallel channel axis and a second inlet opening extending a length of each second cable retention channel, the second body portion having a second base side opposite of each second inlet opening;
wherein the first base side of the first body portion is coupled to the second base side of the second body portion such that each first inlet opening opens in a direction opposite of each second inlet opening.

2. The cable retention clip of claim 1, wherein at least one of:
each first inlet opening of each first cable retention channel opens to form a first common inlet opening region for the pair of first cable retention channels; or
at least a pair of second cable retention channels have second inlet openings that form a second common inlet opening region for that pair of second cable retention channels.

3. The cable retention clip of claim 1, wherein the first body portion is a planar body and the second body portion is a planar body, wherein the first planar body and second planar body are on a common plane, and the pair of first cable retention channels are parallel with the plurality of second cable retention channels.

4. The cable retention clip of claim 1, wherein at least one of:
the length of each first cable retention channel is longer than the length of each second cable retention channel;
a diameter of each first cable retention channel is larger than a diameter of each second cable retention channel;
a thickness of the first body portion is thicker than a thickness of the second body portion;
the second cable retention channels are aligned in a row; or
there is at least one second cable retention channel for each first cable retention channel.

5. The cable retention clip of claim 1, wherein:
the first body is formed by at least two connected C-shaped arms connected together at a first separating region of the first body that is positioned at least partially between the pair of first cable retention channels; and
the second body is formed by a plurality of connected C-shaped arms connected together at a second separating region of the second body that is positioned at least partially between a pair of the second cable retention channels.

6. The cable retention clip of claim 5, wherein the first body and second body are formed of a same resiliently deformable material, wherein the material is selected from a metal coated with an insulation layer, a non-conducting plastic, or a combination thereof.

7. The cable retention clip of claim 1, wherein:
the first body defines the pair of first cable retention channels that are positioned adjacent to each other and each first cable retention channel is dimensioned to retain a lead wire cable therein, each first cable retention channel being formed by a curved first arm extending from a separating region of the first body that is at least partially between the pair of first cable retention channels, each curved first arm forming a first cable channel opening by a first channel gap between an end of the curved first arm and an end of the separating region, a common gap between each curved first arm end that forms a first inlet region for both of the first cable retention channels in the pair; and
the second body portion defines the plurality of second cable retention channels that are positioned adjacent to each other and each second cable retention channel is dimensioned smaller than each first cable retention channel, each second cable retention channel is formed by a curved second arm extending from an adjacent curved second arm, wherein the plurality of second cable retention channels is formed such that each curved second arm forms a second cable channel opening by a second channel gap between an end of the curved second arm and an end of a second separating region at least partially between adjacent second retention channels, a second common gap between at least one pair of curved second arm ends that form a second inlet region for both of the second cable retention channels in the pair.

8. The cable retention clip of claim 1, wherein the first body is coupled to the second body portion with at least one:
elongate member forming a connection between the first body and second body; or
a joining of a material of the first body and the second body to integrate the first body and second body.

9. The cable retention clip of claim 1, wherein the second body includes three second cable retention channels for each first cable retention channel in the first body, and the three second cable retention channels are positioned under and linked to the respective first cable retention channel.

10. The cable retention clip of claim 9, wherein:
the pair of first cable retention channels forms a [symbol] shape;
at least two pairs of second cable retention channels form a [symbol] shape;
a center separating region is between the two sets of three second cable retention channels and forms a branch with each branch arm pointing in opposite directions;
a curved separating member is between each pair of second cable retention channels and adjacent second cable retention channel of each set; and
openings of each [symbol] shape of the first cable retention channels open away from openings of each [symbol] shape of the second cable retention channels.

11. A cable arrangement comprising:
a cable retention clip, comprising:
a first body defining at least a pair of first cable retention channels that are positioned adjacent with each other and each first cable retention channel has a parallel channel axis and a first inlet opening extending a length of each first cable retention channel, the first body portion having a first base side opposite of each first inlet opening; and
a second body defining a plurality of second cable retention channels that are positioned adjacent with each other and each second cable retention channel has a parallel channel axis and a second inlet opening extending a length of each second cable retention channel, the second body portion having a second base side opposite of each second inlet opening;
wherein the first base side of the first body portion is coupled to the second base side of the second body portion such that each first inlet opening opens in a direction opposite of each second inlet opening;
a pair of lead wire cables configured as solar lead wires, each lead wire located in a first cable retention channel; and
a plurality of secondary wire cables configured as solar secondary wires, each secondary wire located in a second cable retention channel.

12. The cable arrangement of claim 11, wherein each lead wire cable is a high tensile lead wire cable that is self-supporting.

13. The cable arrangement of claim 12, wherein the plurality of secondary wire cables are at least one of:
suspended from the pair of lead wire cables by the cable retention clip;
lateral to the pair of lead wire cables and coupled therewith by the cable retention clip; or
held above the pair of lead wire cables by the cable retention clip.

14. The cable arrangement of claim 11, wherein the pair of lead wire cables and plurality of secondary wire cables are suspended from a messenger cable that is anchored between two structural members.

15. The cable arrangement of claim 11, wherein:
the second body includes three second cable retention channels for each first cable retention channel in the first body;
the three second cable retention channels are positioned under and linked to the respective first cable retention channel;
the pair of first cable retention channels forms a [symbol] shape;
at least two pairs of second cable retention channels forms a [symbol] shape;
a center separating region is between the two sets of three second cable retention channels and forms a branch with each branch arm pointing in opposite directions;
a curved separating member is between each pair of second cable retention channels and an adjacent second cable retention channel of each set; and
openings of each [symbol] shape of the first cable retention channels open away from openings of each [symbol] shape of the second cable retention channels.

16. A solar installation, comprising:
a cable retention clip, including:
a first body defining at least a pair of first cable retention channels that are positioned adjacent with each other and each first cable retention channel has a parallel channel axis and a first inlet opening extending a length of each first cable retention channel, the first body portion having a first base side opposite of each first inlet opening; and
a second body defining a plurality of second cable retention channels that are positioned adjacent with each other and each second cable retention channel has a parallel channel axis and a second inlet opening extending a length of each second cable retention channel, the second body portion having a second base side opposite of each second inlet opening;
wherein the first base side of the first body portion is coupled to the second base side of the second body portion such that each first inlet opening opens in a direction opposite of each second inlet opening;
a pair of lead wire cables configured as solar lead wires, each lead wire cable located in a first cable retention channel;
a plurality of secondary wire cables configured as solar secondary wires, each secondary wire cable located in a second cable retention channel; and
at least one solar panel operably coupled with at least one of the lead wire cables or secondary wire cables.

17. The solar installation of claim 16, wherein the cable retention clip holds the pair of lead wire cables and plurality of second wire cables above ground.

18. The solar installation of claim 16, wherein each lead wire cable is a high tensile lead wire cable that is self-supporting.

19. The solar installation of claim 16, wherein the plurality of secondary wire cables are at least one of:
suspended from the pair of lead wire cables by the cable retention clip;
lateral to the pair of lead wire cables and coupled therewith by the cable retention clip; or
held above the pair of lead wire cables by the cable retention clip.

20. The solar installation of claim 16, wherein:
the second body includes three second cable retention channels for each first cable retention channel in the first body;
the three second cable retention channels are positioned under and linked to the respective first cable retention channel;
the pair of first cable retention channels forms a [symbol] shape;
at least two pairs of second cable retention channels forms a [symbol] shape;
a center separating region is between the two sets of three second cable retention channels and forms a branch with each branch arm pointing in opposite directions;
a curved separating member is between each pair of second cable retention channels and an adjacent second cable retention channel of each set; and
openings of each [symbol] shape of the first cable retention channels open away from openings of each [symbol] shape of the second cable retention channels.
